(19) United States
(12) Patent Application Publication
(10) Pub. No.: US 2022/0028258 A1
(43) Pub. Date: Jan. 27, 2022

(54) WARNING PRESENTATION CONTROL DEVICE, WARNING PRESENTATION CONTROL SYSTEM, METHOD OF CONTROLLING WARNING PRESENTATION, AND RECORDING MEDIUM STORING WARNING PRESENTATION CONTROL PROGRAM

(71) Applicant: NEC Corporation, Tokyo (JP)

(72) Inventor: Shogo SADANO, Tokyo (JP)

(73) Assignee: NEC Corporation, Tokyo (JP)

(21) Appl. No.: 17/375,879

(22) Filed: Jul. 14, 2021

(51) Int. Cl. G08G 1/01; G06K 9/00; G06F 3/14; G08G 1/04

(52) U.S. Cl. CPC G08G 1/0141; G06K 9/00718; G06K 9/00785; G08G 1/0116; G08G 1/04; G08G 1/0133; G06F 3/14

(57) ABSTRACT

A warning presentation control device is provided with: a detection unit that detects a dangerous vehicle traveling in a dangerous state on the basis of a traveling state of a vehicle traveling on a road; an estimation unit that estimates a time until another vehicle and the dangerous vehicle approach each other on the basis of a traveling state of the another vehicle traveling in a target area where a presentation unit that presents information presents the information; and a control unit that controls the presentation unit to present warning information for warning of an approach to the dangerous vehicle when the estimated time satisfies a criterion, which improves a warning effect related to occurrence of an accident due to presence of a vehicle in a dangerous traveling state.

This application is based upon and claims the benefit of priority from Japanese Patent Application No. 2020-126125, filed on Jul. 27, 2020, the disclosure of which is incorporated herein in its entirety by reference.

### TECHNICAL FIELD

The present invention relates to a warning presentation control device, a warning presentation control system, a method of controlling warning presentation, and a warning presentation control program.

### BACKGROUND ART

Occurrence of an accident caused by dangerous driving of a vehicle such as tailgating has become a major social problem. Accordingly, a technique for reducing the occurrence of an accident caused by such dangerous driving has been expected.

As a technique related to such a technique, Patent Document 1 (JP 2019-109675 A) discloses a dangerous action eliminating system for the purpose of eliminating a situation of being affected by a dangerous action of a surrounding vehicle. A dangerous action eliminating device in this system obtains surrounding vehicle identification information, detects a position of a vehicle, measures an inter-vehicular distance between the vehicle and the surrounding vehicle, measures a traveling speed of the vehicle, and detects a traveling direction of the vehicle. The dangerous action eliminating device determines that a dangerous action has occurred when a situation in which the inter-vehicular distance is smaller than a predetermined first threshold value and the traveling speed exceeds a predetermined second threshold value occurs within a predetermined time. In a case where a dangerous action has occurred, the dangerous action eliminating device transmits, to a management center device, dangerous action detection information including the surrounding vehicle identification information and information indicating a position, a traveling speed, and a traveling direction. Then, the management center device causes a selected warning output device to output a warning on the basis of the dangerous action detection information.

Furthermore, Patent Document 2 (JP 2014-164524 A) discloses a dangerous vehicle detection device installed on the upstream side in a vehicle traveling direction of a maintenance work site on a vehicle passage road. This device grasps the behavior of each vehicle traveling in a predetermined area to be monitored on the upstream side of the maintenance work site in the vehicle traveling direction, and performs machine learning on the normal behavior of a vehicle in the area to be monitored. This device detects a vehicle exhibiting a behavior deviating from the learned normal behavior as a dangerous vehicle, and generates alarm signals to wirelessly transmit them to an alarm unit. In the case of receiving the alarm signals, the alarm unit performs a predetermined alarm.

Furthermore, Patent Document 3 (WO 2019/163980 A) discloses a driving behavioral data generation device that obtains, from an in-vehicle sensor mounted on a vehicle, driving information associated with driving of the vehicle. This device collates the obtained driving information with structural information of a known traveling road in advance, and determines a travel history including a vehicle position a travel path in units of lanes of the traveling road. This device classifies the information associated with the determined travel history in units of lanes of the traveling road with at least one of a vehicle condition on the motion performance of the vehicle and a surrounding environmental condition when the vehicle travels as a classification requirement. Then, this device generates, for a vehicle traveling on the traveling road in a specific region, driving behavioral data to be used when guidance regarding at least one of a route and a speed that can be taken by the vehicle is carried out for each classified classification requirement.

### SUMMARY

A main object of the present invention is to provide a warning presentation control device and the like that improve a warning effect related to occurrence of an accident due to presence of a vehicle in a dangerous traveling state.

A warning presentation control device according to one aspect of the present invention is provided with: a detection unit that detects a dangerous vehicle traveling in a dangerous state on the basis of a traveling state of a vehicle traveling on a road; an estimation unit that estimates a time until another vehicle and the dangerous vehicle approach each other on the basis of a traveling state of the another vehicle traveling in a target area where a presentation device that presents information presents the information; and a control unit that controls the presentation device to present warning information for warning of an approach to the dangerous vehicle when the estimated time satisfies a criterion.

From another standpoint of achieving the above object, a method of controlling warning presentation according to one aspect of the present invention uses an information processing apparatus to detect a dangerous vehicle traveling in a dangerous state on the basis of a traveling state of a vehicle traveling on a road, estimate a time until another vehicle and the dangerous vehicle approach each other on the basis of a traveling state of the another vehicle traveling in a target area where a presentation device that presents information presents the information, and control the presentation device to present warning information for warning of an approach to the dangerous vehicle when the estimated time satisfies a criterion.

From still another standpoint of achieving the above object, a warning presentation control program according to one aspect of the present invention causes a computer to execute a detection process of detecting a dangerous vehicle traveling in a dangerous state on the basis of a traveling state of a vehicle traveling on a road, an estimation process of estimating a time until another vehicle and the dangerous vehicle approach each other on the basis of a traveling state of the another vehicle traveling in a target area where a presentation device that presents information presents the information, and a control process of controlling the presentation device to present warning information for warning of an approach to the dangerous vehicle when the estimated time satisfies a criterion.

Moreover, the present invention may also be achieved by a non-volatile computer-readable recording medium storing the warning presentation control program (computer program).

### BRIEF DESCRIPTION OF THE DRAWINGS

FIG. 1 is a diagram illustrating an outline of a warning presentation control system according to a first example embodiment of the present invention;

FIG. 2 is a block diagram illustrating a configuration of the warning presentation control system according to the first example embodiment of the present invention;

FIG. 3 is a flowchart illustrating operation of the warning presentation control system according to the first example embodiment of the present invention;

FIG. 4 is a block diagram illustrating a configuration of a warning presentation control device according to a second example embodiment of the present invention; and

FIG. 5 is a block diagram illustrating a configuration of an information processing apparatus capable of achieving the warning presentation control device according to each example embodiment of the present invention.

### EXAMPLE EMBODIMENT

Hereinafter, example embodiments of the present invention will be detailed with reference to the accompanying drawings.

### First Example Embodiment

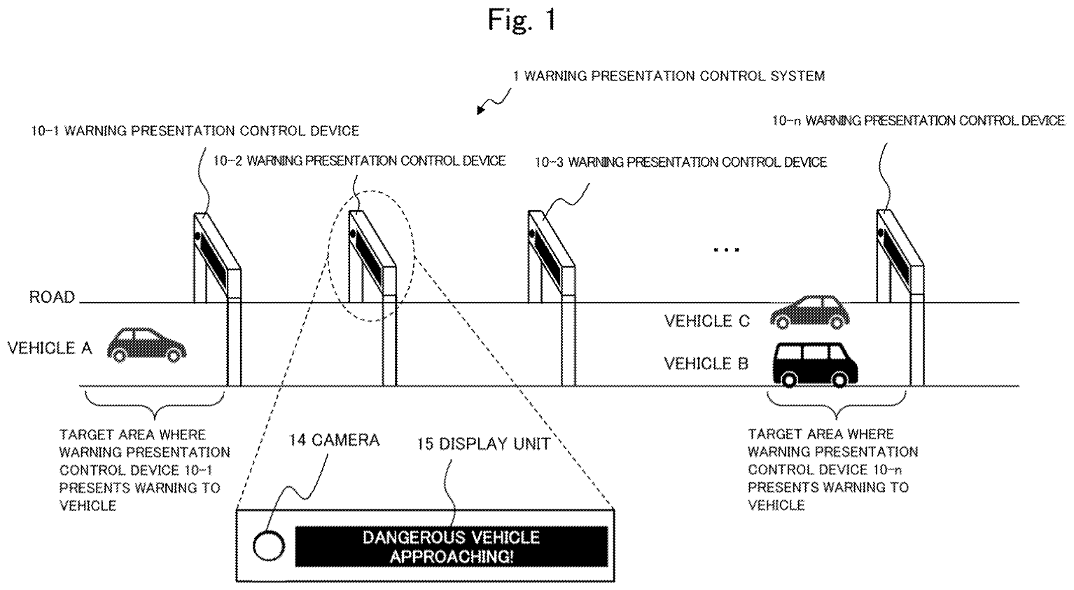

FIG. 1 is a diagram illustrating an outline of a warning presentation control system 1 according to a first example embodiment of the present invention. The warning presentation control system 1 includes n (n is any integer of equal to or more than 2) warning presentation control devices 10-1 to 10-n installed at different places on a road. In the following descriptions of the present example embodiment, any one of the warning presentation control devices 10-1 to 10-n or the warning presentation control devices may be collectively referred to as a warning presentation control device 10.

The warning presentation control device 10 images vehicles traveling on a road with a camera 14, and detects a dangerous vehicle traveling in a dangerous state that may be a factor of accident occurrence from among the imaged vehicles. In a case where a dangerous vehicle has been detected, the warning presentation control device 10 displays a warning such as “dangerous vehicle approaching!” on a display unit 15 in such a manner that a driver of a vehicle traveling in a warning target area of each warning presentation control device 10 on the road can visually recognize it. The warning target area is a target area in which each warning presentation control device 10 presents a warning to a vehicle traveling on a road. More specifically, the warning target area is an area behind the position of the warning presentation control device 10 in the traveling direction of the road and within a distance in which the driver of the vehicle can visually recognize the warning displayed on the display unit 15.

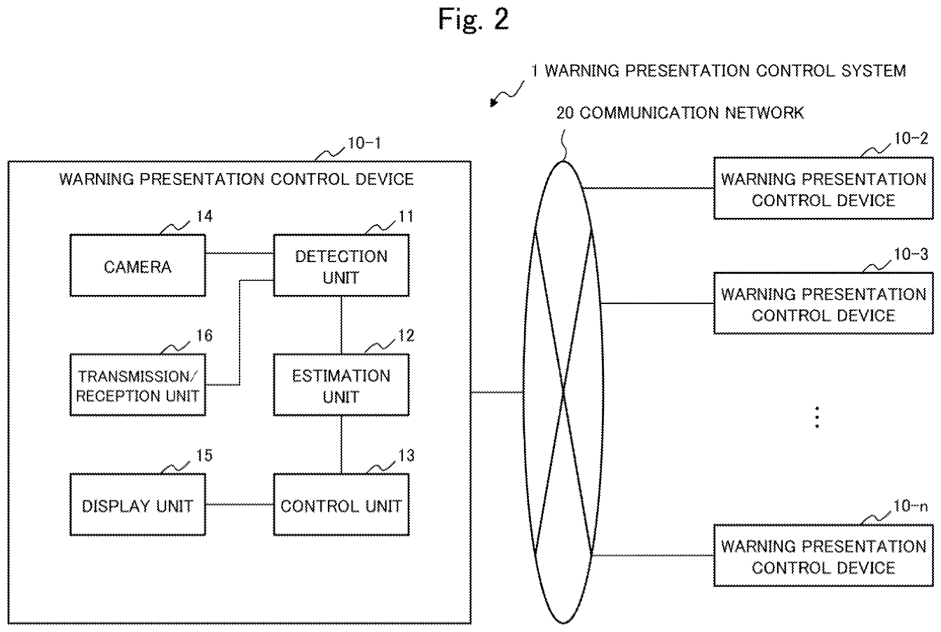

FIG. 2 is a block diagram illustrating a configuration of the warning presentation control system 1 according to the present example embodiment. In the warning presentation control system 1, the warning presentation control devices 10-1 to 10-n are communicably connected to each other by a communication network 20. The communication network 20 may be, for example, the Internet, or may be a communication network constructed by a dedicated communication line.

Each warning presentation control device 10 includes a detection unit 11, an estimation unit 12, a control unit 13, a camera 14, a display unit 15, and a transmission/reception unit 16. The detection unit 11, the estimation unit 12, the control unit 13, the camera 14, and the display unit 15 are examples of a detection means, an estimation means, a control means, an acquisition means, and a presentation means, in that order.

The detection unit 11 analyzes video showing a traveling state of a vehicle traveling on the road, which is imaged by the camera 14, using an existing image analysis technique, for example, and calculates a traveling state such as a traveling speed, a traveling direction, and a positional relationship with another vehicle for each vehicle. In a case where the traveling state of a certain vehicle indicates that it is dangerous, the detection unit 11 detects the vehicle as a dangerous vehicle. A criterion related to a traveling state of a vehicle for determining as a dangerous vehicle is given to the detection unit 11, and the detection unit 11 detects, as a dangerous vehicle, a vehicle whose traveling state is as follows, for example.
The traveling speed is faster than the average value of traveling speeds of other vehicles traveling in the vicinity thereof by equal to or more than a threshold value.
The traveling speed is slower than the average value of traveling speeds of other vehicles traveling in the vicinity thereof by equal to or more than a threshold value.
It is traveling at a speed equal to or more than a certain speed, and the inter-vehicular distance with the vehicle traveling in front is equal to or less than a threshold value.
The inter-vehicular distance with a vehicle traveling in parallel is equal to or less than a threshold value.
It is traveling in a meandering manner.
It is traveling against the traveling direction of the road.

The traveling states of the dangerous vehicle described above are examples, and the criterion for the traveling state when the detection unit 11 determines that it is a dangerous vehicle is not limited to the above. In the case of detecting a dangerous vehicle traveling in the wrong direction, the warning presentation control device 10 is preferably equipped with the camera 14 also on the surface opposite to the surface on which the display unit 15 is installed in FIG. 1 to be capable of imaging the dangerous vehicle traveling in the wrong direction.

The detection unit 11 notifies the estimation unit 12 and the control unit 13 of the detection result of the dangerous vehicle and the traveling state of the dangerous vehicle. The detection unit 11 also transmits the detection result of the dangerous vehicle and the traveling state of the dangerous vehicle to other warning presentation control devices 10 via the transmission/reception unit 16 with the identifier of the warning presentation control device 10 itself included therein. That is, in the warning presentation control system 1, the warning presentation control devices 10-1 to 10-n share the detection result of the dangerous vehicle in the individual warning presentation control device 10. The detection unit 11 notifies the estimation unit 12 and the control unit 13 of the detection result of the dangerous vehicle and the traveling state of the dangerous vehicle received from another warning presentation control device 10 via the transmission/reception unit 16. The detection unit 11 may also notify the estimation unit 12, the control unit 13, and other warning presentation control devices 10 of characteristics of an appearance (e.g., vehicle type, color, etc.) of the dangerous vehicle that can be obtained from the video of the dangerous vehicle. From the viewpoint of personal information protection, the detection unit 11 does not preferably include personal information related to the dangerous vehicle (e.g., number of the car registration plate, etc.) in the information to be notified.

The estimation unit 12 estimates a time until the dangerous vehicle and another vehicle traveling in the warning target area of the warning presentation control device 10 of its own approach each other on the basis of the detection result of the dangerous vehicle notified from the detection unit 11 and the traveling state of the vehicle traveling on the road shown in the video captured by the camera 14. The approach of the dangerous vehicle to the another vehicle specifically indicates that the distance between the dangerous vehicle and the another vehicle becomes equal to or less than a predetermined distance (e.g., 10 m), for example.

Examples of the case where a dangerous vehicle and another vehicle approach each other include the following three cases.

(Case 1) A dangerous vehicle with a high traveling speed approaches other vehicles from behind.

In this case, the warning presentation control system 1 needs to warn the other vehicles traveling ahead of the dangerous vehicle in the traveling direction of the road that the dangerous vehicle with a high traveling speed is approaching from behind.

(Case 2) Other vehicles approach from behind a dangerous vehicle with a low traveling speed.

In this case, the warning presentation control system 1 needs to warn the other vehicles traveling behind the dangerous vehicle in the traveling direction of the road that the dangerous vehicle with a low traveling speed is traveling ahead.

(Case 3) A dangerous vehicle traveling in the wrong direction on the road approaches other vehicles from the front.

In this case, the warning presentation control system 1 needs to warn the other vehicles traveling behind the dangerous vehicle in the traveling direction of the road that the dangerous vehicle traveling in the wrong direction on the road is approaching from the front.

For example, it is assumed that, in the warning presentation control system 1 exemplified in FIG. 1, the detection unit 11 of the warning presentation control device 10-1 has determined a vehicle A traveling at a speed significantly exceeding the average value of traveling speeds of other vehicles (speed equal to or more than a first reference speed) with respect to the traveling direction of the road to be a dangerous vehicle, as an example of Case 1 mentioned above. In this case, the estimation unit 12 of individual warning presentation control device 10-i (i is any integer from 1 to n) estimates (calculates) a time tᵢ until the vehicle A approaches another vehicle traveling in the warning target area of the warning presentation control device 10-i on the basis of the traveling speeds of the vehicle A and the another vehicle. More specifically, the estimation unit 12 may use a relative speed between the vehicle A and the another vehicle. However, in this case, the vehicle A has already approached the another vehicle in the warning target area of the warning presentation control device 10-1, and thus a time t₁ is zero. It is assumed that information in which positions at which the warning presentation control devices 10-1 to 10-n are installed are associated with identification information of the warning presentation control devices 10-1 to 10-n is given to the estimation unit 12 in advance in such a way that the time tᵢ can be estimated on the basis of the information associated with the dangerous vehicle obtained from another warning presentation control device 10.

For example, it is assumed that, in the warning presentation control system 1 exemplified in FIG. 1, the detection unit 11 of the warning presentation control device 10-n has determined a vehicle B traveling at a speed significantly lower than the average value of traveling speeds of other vehicles (speed equal to or less than a second reference speed) with respect to the traveling direction of the road to be a dangerous vehicle, as an example of Case 2 mentioned above. In this case, the estimation unit 12 of individual warning presentation control device 10-i estimates the time tᵢ until another vehicle approaches the vehicle B traveling in the warning target area of the warning presentation control device 10-i on the basis of the traveling speeds of the vehicle B and the another vehicle. More specifically, the estimation unit 12 may use a relative speed between the vehicle B and the another vehicle. However, in this case, the another vehicle has already approached the vehicle B at the position where the warning presentation control device 10-n is installed, and thus a time tₙ is zero. In the present example embodiment, it is assumed that, when a dangerous vehicle and another vehicle approach each other, collision or the like between the dangerous vehicle and the another vehicle is avoided and no accident occurs.

For example, it is assumed that, in the warning presentation control system 1 exemplified in FIG. 1, the detection unit 11 of the warning presentation control device 10-n has determined a vehicle C traveling against the traveling direction of the road to be a dangerous vehicle, as an example of Case 3 mentioned above. In this case, the estimation unit 12 of individual warning presentation control device 10-i estimates the time tᵢ during which another vehicle traveling in the vicinity of the position at which the warning presentation control device 10-i is installed approaches the vehicle C on the basis of the traveling speeds of the vehicle C and the another vehicle. More specifically, the estimation unit 12 may use a relative speed between the vehicle C and the another vehicle. However, in this case, the another vehicle has already approached the vehicle C at the position where the warning presentation control device 10-n is installed, and thus the time tₙ is zero. The estimation unit 12 notifies the control unit 13 of a result of the estimation of the time until the dangerous vehicle approaches the another vehicle traveling at the position where the warning presentation control device 10 of its own is installed.

In a case where the time estimated by the estimation unit 12 satisfies the criterion, the control unit 13 controls the display unit 15 to present warning information for warning drivers of other vehicles traveling on the road of the approach to the dangerous vehicle.

For example, in the case of the example of Case 1 described above, the control unit 13 in the warning presentation control device 10-i determines whether the time tᵢ estimated by the estimation unit 12 is equal to or less than a threshold value (e.g., 5 minutes). For example, in a case where i satisfying the conditions described above is 1 to 3, the control unit 13 in the warning presentation control devices 10-1 to 10-3 displays the warning information for warning of the approach to the dangerous vehicle on the display unit 15. The control unit 13 in the warning presentation control devices 10-4 to 10-n does not display the warning information on the display unit 15.

The warning information displayed on the display unit 15 may include information indicating at least one of a traveling state of the dangerous vehicle, characteristics of the appearance of the dangerous vehicle, and the time tᵢ. In a case where the warning information includes the traveling state of the dangerous vehicle, the characteristics of the appearance of the dangerous vehicle, and the time tᵢ, the control unit 13 may display, on the display unit 15, a warning such as “a white wagon with a high traveling speed will approach from behind after 3 minutes”. In this case, the value “after 3 minutes” represents the time tᵢ.

For example, in the case of the example of Case 2 described above, the control unit 13 in the warning presentation control device 10-i determines whether the time tᵢ estimated by the estimation unit 12 is equal to or less than a threshold value (e.g., 5 minutes). For example, in a case where i satisfying the conditions described above is n−3 to n, the control unit 13 in the warning presentation control devices 10-(n−3) to 10-n displays the warning information for warning of the approach to the dangerous vehicle on the display unit 15. The control unit 13 in the warning presentation control devices 10-1 to 10-(n−4) does not display the warning information on the display unit 15.

In a case where the warning information includes the traveling state of the dangerous vehicle, the characteristics of the appearance of the dangerous vehicle, and the time tᵢ, the control unit 13 may display, on the display unit 15, a warning such as “approaching a black light car ahead with a low traveling speed after 4 minutes”.

In the case of the example of Case 3 described above as well, the control unit 13 operates in a similar manner to the cases of the examples of Case 1 and Case 2 described above. In this case, the control unit 13 in the warning presentation control device 10-i in which the time tᵢ estimated by the estimation unit 12 is equal to or less than the threshold value may display, on the display unit 15, a warning such as “a silver sedan traveling in the wrong direction will approach after 5 minutes”.

As described above, in a case where the dangerous vehicle is traveling at a speed equal to or more than the first reference speed with respect to the traveling direction on the road, the control unit 13 in at least one of the warning presentation control devices 10 located ahead of the dangerous vehicle in the traveling direction controls the display unit 15 to present warning information. In addition, in a case where the dangerous vehicle is traveling at a speed equal to or less than the second reference speed with respect to the traveling direction on the road, the control unit 13 in at least one of the warning presentation control devices 10 located behind the dangerous vehicle in the traveling direction controls the display unit 15 to present warning information.

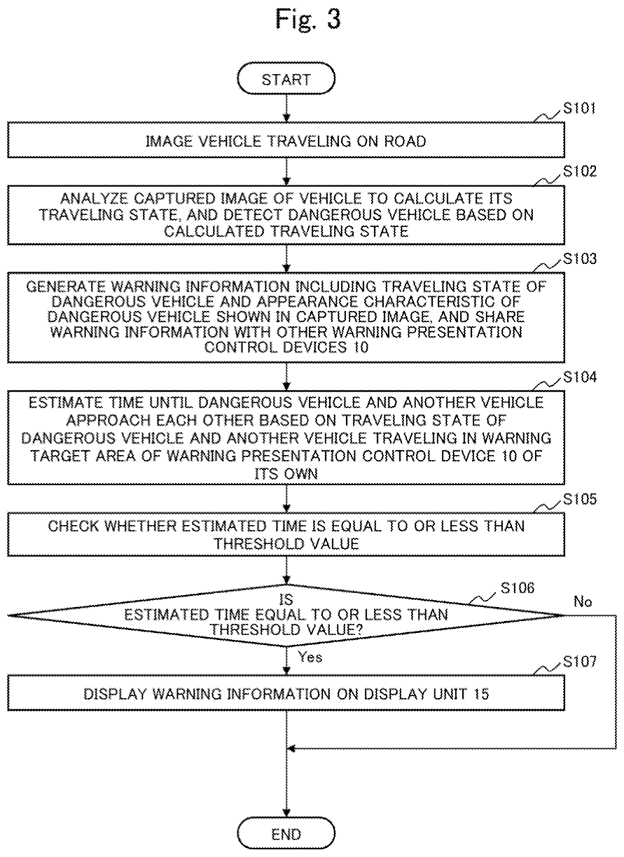

Next, operation (processing) of the warning presentation control device 10 according to the present example embodiment will be described in detail with reference to a flowchart of FIG. 3.

In each warning presentation control device 10, the camera 14 images a vehicle traveling on a road (step S101). In each warning presentation control device 10, the detection unit 11 analyzes the captured image of the vehicle to calculate a traveling state thereof, and detects a dangerous vehicle on the basis of the calculated traveling state (step S102). The detection unit 11 generates warning information including the traveling state of the dangerous vehicle and characteristics of the appearance of the dangerous vehicle shown in the captured image, and transmits the warning information to other warning presentation control devices 10, thereby sharing the warning information with the other warning presentation control devices 10 (step S103).

In each warning presentation control device 10, the estimation unit 12 estimates, on the basis of the traveling states of the dangerous vehicle and another vehicle traveling in the warning target area of the warning presentation control device 10 of its own, a time until the another vehicle and the dangerous vehicle approach each other (step S104). In each warning presentation control device 10, the control unit 13 checks whether the time estimated by the estimation unit 12 is equal to or less than a threshold value (step S105).

If the time estimated by the estimation unit 12 is not equal to or less than the threshold value (No in step S106), the entire process is terminated. If the time estimated by the estimation unit 12 is equal to or less than the threshold value (Yes in step S106), the control unit 13 displays warning information on the display unit 15 (step S107), and the entire process is terminated.

The warning presentation control device 10 according to the present example embodiment can improve a warning effect related to occurrence of an accident due to presence of a vehicle in a dangerous traveling state. This is because the warning presentation control device 10 estimates a time until the detected dangerous vehicle and a vehicle traveling in the warning target area of its own approach each other, and displays warning information for warning of the approach to the dangerous vehicle on the display unit 15 in which the estimated time satisfies a criterion.

Hereinafter, effects to be exerted by the warning presentation control device 10 according to the present example embodiment will be described in detail.

For example, on a road such as an express way, various pieces of information indicating a weather condition, a traffic congestion occurrence status, an accident occurrence status, a place name of each branch destination at a branch point of the road, and the like are displayed. While a driver of a vehicle needs to pay attention to those various pieces of information during driving, the more the amount of information to be provided, the higher the possibility of missing a part of the information. Therefore, in the case of providing information for warning of occurrence of an accident due to presence of a vehicle in a dangerous traveling state, there is a problem that the more the amount of information to be provided, the higher the possibility of missing a part of the information for the driver, thereby reducing the warning effect.

In view of such a problem, the warning presentation control device 10 according to the present example embodiment includes the detection unit 11, the estimation unit 12, and the control unit 13, and operates as described above with reference to FIGS. 1 to 3, for example. That is, in the warning presentation control system 1 according to the present example embodiment, the warning presentation control device 10 including the camera 14 and the display unit 15 is installed at multiple positions on the road. The detection unit 11 in each warning presentation control device 10 detects a dangerous vehicle traveling on the road in a dangerous state on the basis of the traveling states of vehicles obtained by the camera 14. The estimation unit 12 estimates a time until a vehicle traveling in the warning target area and the dangerous vehicle approach each other on the basis of the traveling states of the dangerous vehicle and other vehicles. Then, the control unit 13 controls the display unit 15 in which the estimated time satisfies a criterion to present warning information for warning of the approach to the dangerous vehicle.

That is, each warning presentation control device 10 according to the present example embodiment does not display the warning information on the display units 15 of all the warning presentation control devices 10, but displays the warning information on the display unit 15 at a position where a vehicle that is about to approach the dangerous vehicle travels. In other words, the warning presentation control device 10 does not display the warning information on the display unit 15 at a position where a vehicle not facing an imminent threat of accident occurrence travels. As described above, the warning presentation control device 10 can enhance the warning effect related to the accident occurrence by calling attention to drivers of vehicles limited to the vehicles that are about to approach the dangerous vehicle.

The warning presentation control device 10 according to the present example embodiment may include, in the warning information, a time until the dangerous vehicle and the vehicle traveling in the warning target area approach each other, and a traveling state and appearance characteristics of the dangerous vehicle. As a result, a driver of a vehicle to which the warning information is presented can obtain detailed information associated with the dangerous vehicle, and thus the warning presentation control device 10 can enhance the warning effect related to the accident occurrence.

The warning presentation control device 10 according to the present example embodiment may include a measuring instrument that measures a traveling speed of a vehicle, such as ORBIS (registered trademark), instead of the camera 14 or in addition to the camera 14.

The warning presentation control device 10 according to the present example embodiment may include a speaker that outputs warning information by voice, for example, instead of the display unit 15 or in addition to the display unit 15.

In a case where a plurality of the warning presentation control devices 10 detect the same dangerous vehicle, the warning presentation control system 1 may adjust processing of information associated with the dangerous vehicle among the plurality of warning presentation control devices 10. For example, the warning presentation control system 1 may share the information associated with the dangerous vehicle generated by the warning presentation control device 10 closest to the dangerous vehicle, or may apply weighting based on the distance to the dangerous vehicle to the information associated with the dangerous vehicle.

Although a plurality of the warning presentation control devices 10 each including the detection unit 11, the estimation unit 12, the control unit 13, the camera 14, the display unit 15, and the transmission/reception unit 16 mutually transmits and receives information associated with a dangerous vehicle and warning information in the warning presentation control system 1 described above, the configuration of the warning presentation control system 1 is not limited to such a configuration. For example, the warning presentation control system 1 may be a centrally managed system in which multiple devices each including the camera 14, the display unit 15, and the transmission/reception unit 16 are installed at multiple positions on the road and one warning presentation control device 10 including the detection unit 11, the estimation unit 12, the control unit 13, and the transmission/reception unit 16 is installed in a data center or the like. In this case, it is sufficient if the warning presentation control device 10 is communicably connected to the multiple devices installed on the road, and controls the display units 15 of the multiple devices as described above on the basis of the video of vehicles imaged by the cameras 14 of the multiple devices.

### Second Example Embodiment

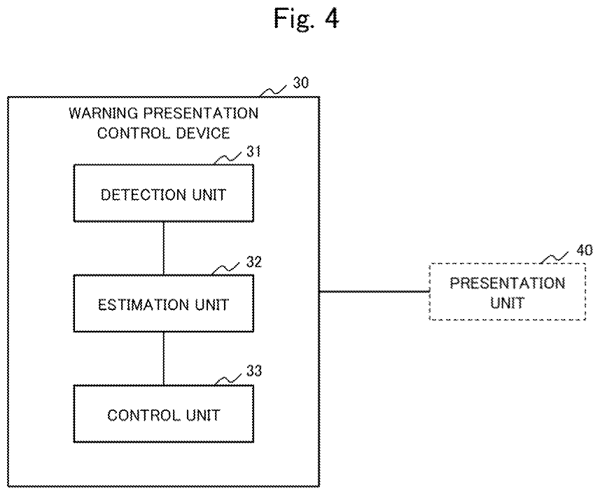

FIG. 4 is a block diagram illustrating a configuration of a warning presentation control device 30 according to a second example embodiment of the present invention. The warning presentation control device 30 is a device that presents warning information for warning of an approach to a dangerous vehicle to a vehicle traveling on a road via a presentation unit 40. The presentation unit 40 is an example of a presentation means, which presents, under external control, warning information to a vehicle traveling on a road like the display unit 15 according to the first example embodiment, for example.

The warning presentation control device 30 according to the present example embodiment includes a detection unit 31, an estimation unit 32, and a control unit 33. The detection unit 31, the estimation unit 32, and the control unit 33 are examples of a detection means, an estimation means, and a control means, in that order.

The detection unit 31 detects a dangerous vehicle traveling in a dangerous state on the basis of a traveling state of a vehicle traveling on a road. The detection unit 31 is capable of obtaining a traveling state of a vehicle from a device such as the camera 14 according to the first example embodiment, for example. For example, in a similar manner to the detection unit 11 according to the first example embodiment, the detection unit 31 may calculate, for each vehicle, a traveling state such as a traveling speed, a traveling direction, and a positional relationship with another vehicle. A traveling state of a vehicle for determining as a dangerous vehicle is given to the detection unit 31, and the detection unit 31 detects, for example, a vehicle in a dangerous traveling state exemplified in the first example embodiment as a dangerous vehicle.

On the basis of a traveling state of a vehicle traveling on the road, for example, in a similar manner to the estimation unit 12 according to the first example embodiment, the estimation unit 32 estimates a time until another vehicle traveling in a target area of information presentation of the presentation unit 40 that presents information and the dangerous vehicle approach each other on the basis of the traveling state of the another vehicle. More specifically, the estimation unit 32 estimates the time on the basis of the relative speed between the dangerous vehicle and the vehicle traveling in the target area, for example.

The control unit 33 controls the presentation unit 40 to present warning information for warning of the approach to the dangerous vehicle in the case where the time estimated by the estimation unit 32 satisfies a criterion. For example, in a similar manner to the control unit 13 according to the first example embodiment, the control unit 33 controls the presentation unit 40 in which the time until the dangerous vehicle and the another vehicle traveling in the warning target area approach each other is equal to or less than a threshold value to present the warning information in the examples of Cases 1 to 3 described above.

The warning presentation control device 30 according to the present example embodiment can improve a warning effect related to occurrence of an accident due to presence of a vehicle in a dangerous traveling state. This is because the warning presentation control device 30 estimates a time until the detected dangerous vehicle and a vehicle traveling in the warning target area approach each other, and presents warning information for warning of the approach to the dangerous vehicle via the presentation unit 40 in which the estimated time satisfies a criterion.

<Exemplary Hardware Configuration>

Each unit in the warning presentation control device illustrated in FIGS. 2 and 4 in each example embodiment described above can be constructed by dedicated hardware (HW) (electronic circuit). In FIGS. 2 and 4, at least the following configurations can be regarded as function (processing) units (software module) of software programs including commands to be executed by a processor.
Detection units 11 and 31;
Estimation units 12 and 32;
Control units 13 and 33;
Control function of the camera 14;
Control function of the display unit 15; and
Control function of the transmission/reception unit 16.

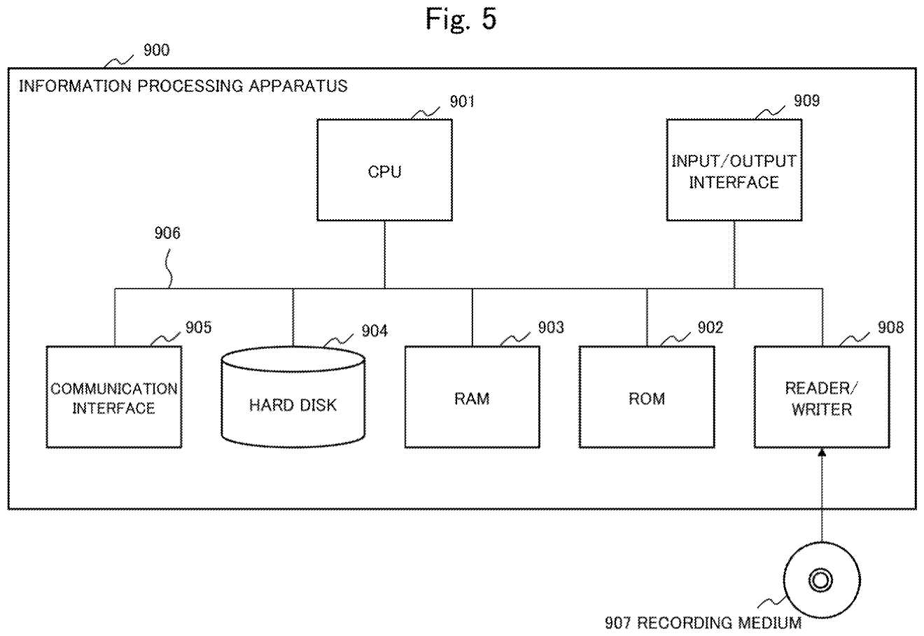

However, the segmentation of each unit illustrated in those drawings is a configuration for convenience of description, and various configurations can be assumed at the time of implementation. An exemplary hardware environment in this case will be described with reference to FIG. 5.

FIG. 5 is a diagram exemplarily illustrating a configuration of an information processing apparatus 900 (computer) capable of constructing the warning presentation control device according to each example embodiment of the present invention. That is, FIG. 5 illustrates a configuration of a computer (information processing apparatus) capable of constructing the warning presentation control device illustrated in FIGS. 2 and 4, which represents a hardware environment capable of implementing each function in the example embodiments described above.

The information processing apparatus 900 illustrated in FIG. 5 includes the following items as constituent elements.
Central processing unit (CPU) 901;
Read only memory (ROM) 902;
Random access memory (RAM) 903;
Hard disk (storage device) 904;
Communication interface 905;
Bus 906 (communication line);
Reader/writer 908 capable of reading and writing data stored in a recording medium 907 such as a compact disc read only memory (CD-ROM); and
Input/output interface 909 such as a monitor, a speaker, and a keyboard.

In other words, the information processing apparatus 900 including the constituent elements mentioned above is a general computer to which those components are connected via the bus 906. The information processing apparatus 900 may include a plurality of the CPUs 901, or may include the CPU 901 configured as a multi-core CPU.

The present invention described using the example embodiments described above as examples supplies a computer program capable of implementing the following functions for the information processing apparatus 900 illustrated in FIG. 5. The functions indicate the above-described configurations in the block configuration diagrams (FIGS. 2 and 4) referred to in the descriptions of the example embodiments, or the functions in the flowchart (FIG. 3). The present invention is achieved by reading, interpreting, and executing the computer program in the CPU 901 of the hardware thereafter. It is sufficient if the computer program supplied into the device is stored in a readable/writable volatile memory (RAM 903), or in a nonvolatile storage device such as the ROM 902 or the Hard disk 904.

In the case described above, a general procedure can be adopted at present as a method of supplying the computer program into the hardware. Examples of the procedure include a method of installing it in the device via various recording media 907 such as a CD-ROM, and a method of downloading it from the outside via a communication line such as the Internet. In such a case, the present invention can be regarded as being configured by codes constituting the computer program or the recording medium 907 storing the codes.

The present invention has been particularly shown and described using the above-described exemplary embodiments as model examples. However, the present invention is not limited to the above-described exemplary embodiments. It will be understood by those of ordinary skill in the art that various embodiments may be applied in the present invention without departing from the spirit and scope of the present invention as defined by the claims.

1. A warning presentation control device comprising:
at least one memory storing a computer program; and
at least one processor configured to execute the computer program to
detect a dangerous vehicle traveling in a dangerous state based on a traveling state of a vehicle traveling on a road,
estimate a time until another vehicle and the dangerous vehicle approach each other based on a traveling state of the another vehicle traveling in a target area where a presentation device that presents information presents the information, and
control the presentation device to present warning information for warning of an approach to the dangerous vehicle when the time having been estimated satisfies a criterion.

2. The warning presentation control device according to claim 1, wherein the processor is configured to execute the computer program to
control the presentation device to present the warning information indicating the time having been estimated.

3. The warning presentation control device according to claim 1, wherein the processor is configured to execute the computer program to
detect the dangerous vehicle by analyzing video showing the traveling state of the vehicle.

4. The warning presentation control device according to claim 3, wherein the processor is configured to execute the computer program to
control the presentation device to present the warning information indicating a characteristic of a traveling state of the dangerous vehicle.

5. The warning presentation control device according to claim 3, wherein the processor is configured to execute the computer program to
determine a characteristic of an appearance of the dangerous vehicle, and
control the presentation device to present the warning information indicating the characteristic of the appearance of the dangerous vehicle.

6. The warning presentation control device according to claim 1, wherein the processor is configured to execute the computer program to
control the presentation device located ahead of the dangerous vehicle in a traveling direction to present the warning information when the dangerous vehicle is traveling at a speed equal to or more than a first reference speed with respect to the traveling direction on the road, and
control the presentation device located behind the dangerous vehicle in the traveling direction to present the warning information when the dangerous vehicle is traveling at a speed equal to or less than a second reference speed with respect to the traveling direction on the road.

7. A warning presentation control system comprising:
a plurality of the warning presentation control devices according to claim 1, wherein
each of the plurality of warning presentation control devices includes an acquisition device that obtains the traveling state of the vehicle and the presentation device, and
a first warning presentation control device of the plurality of warning presentation control devices controls the presentation device in at least one of the first and second warning presentation control devices of the plurality of warning presentation control devices.

8. A warning presentation control system comprising:
the warning presentation control device according to claim 1; and
a plurality of acquisition devices that obtains the traveling state of the vehicle and a plurality of the presentation devices included in a plurality of devices different from the warning presentation control device.

9. A method of controlling warning presentation using an information processing apparatus, the method comprising:
detecting a dangerous vehicle traveling in a dangerous state based on a traveling state of a vehicle traveling on a road;
estimating a time until another vehicle and the dangerous vehicle approach each other based on a traveling state of the another vehicle traveling in a target area where a presentation device that presents information presents the information; and
controlling the presentation device to present warning information for warning of an approach to the dangerous vehicle when the time having been estimated satisfies a criterion.

10. A non-volatile computer-readable recording medium storing a warning presentation control program for causing a computer to perform:
a detection process of detecting a dangerous vehicle traveling in a dangerous state based on a traveling state of a vehicle traveling on a road;
an estimation process of estimating a time until another vehicle and the dangerous vehicle approach each other based on a traveling state of the another vehicle traveling in a target area where a presentation device that presents information presents the information; and
a control process of controlling the presentation device to present warning information for warning of an approach to the dangerous vehicle when the time having been estimated satisfies a criterion.
